(19) United States
(12) Patent Application Publication
(10) Pub. No.: US 2026/0187133 A1
(43) Pub. Date: Jul. 2, 2026

(54) INFORMATION GENERATION DEVICE AND COMPUTER-READABLE STORAGE MEDIUM

(71) Applicant: Fanuc Corporation, Minamitsuru-gun, Yamanashi (JP)

(72) Inventors: Yuuki SUGITA, Minamitsuru-gun, Yamanashi (JP); Nobuaki AIZAWA, Minamitsuru-gun, Yamanashi (JP)

(73) Assignee: Fanuc Corporation, Minamitsuru-gun, Yamanashi (JP)

(21) Appl. No.: 18/727,888

(22) PCT Filed: Jan. 21, 2022
(86) PCT No.: PCT/JP2022/002290

§ 371 Date: Jul. 10, 2024

(51) Int. Cl. G06F 16/36; G06F 40/242

(52) U.S. Cl. CPC G06F 16/36; G06F 40/242

(57) ABSTRACT

An information generation device includes: a program acquisition unit acquiring a program executed in a control device that controls industrial machinery; an extraction unit extracting, from the program acquired by the program acquisition unit, elements constituting the program and additional information added to the elements; and a dictionary creation unit creating a dictionary in which the elements and additional information extracted by the extraction unit are associated with each other.

### CROSS REFERENCE TO RELATED APPLICATIONS

This is the U.S. National Phase application of PCT/JP2022/002290 filed Jan. 21, 2022, the disclosures of these applications being incorporated herein by reference in their entireties for all purposes.

### FIELD OF THE INVENTION

The present disclosure relates to an information generation device and a computer-readable storage medium.

### BACKGROUND OF THE INVENTION

Conventionally, systems to display various signals indicating control states of an industrial machine on a viewing screen are known (Patent Literature 1). In such systems, an input/output timings of multiple types of signals are displayed on the viewing screen.

### PATENT LITERATURE

Patent Literature 1: Japanese Patent Application Laid-Open No. 2020-175534

### SUMMARY OF THE INVENTION

In the conventional system, however, even with display of various signals on the viewing screen, it is difficult to make the operator understand what kind of control state the control device is in. For example, the operator is required to have much experience to understand what kind of operation is being performed in an industrial machine by looking at the states of various signals displayed on the viewing screen. That is, it is difficult for an inexperienced operator to understand the operation being performed in the industrial machine even by looking at the states of various signals.

The present disclosure intends to provide an information generation device and a computer-readable storage medium that enable the operator to easily understand the control state of a control device.

An information generation device includes: a program acquisition unit that acquires a program executed in a control device configured to control an industrial machine; an extraction unit that extracts, from the program acquired by the program acquisition unit, an element forming the program and additional information added to the element; and a dictionary creation unit that creates a dictionary in which the element and the additional information extracted by the extraction unit are associated with each other.

A computer-readable storage medium stores an instruction that causes a computer to perform: acquiring a program executed in a control device configured to control an industrial machine; extracting, from the acquired program, an element forming the program and additional information added to the element; and creating a dictionary in which the extracted element and the extracted additional information are associated with each other.

According to one aspect of the present disclosure, it is possible to make the operator easily understand the control state of a control device.

### BRIEF DESCRIPTION OF DRAWINGS

FIG. 1 is a block diagram illustrating an example of a hardware configuration of an industrial machine.

FIG. 2 is a block diagram illustrating an example of a function of an information generation device implemented on a control device.

FIG. 3 is a diagram illustrating an example of a machining program.

FIG. 4 is a diagram illustrating an example of information registered in a dictionary.

FIG. 5 is a diagram illustrating an example of a ladder program.

FIG. 6 is a diagram illustrating an example of information registered in a dictionary.

FIG. 7 is a diagram illustrating an example of an embedded program.

FIG. 8 is a diagram illustrating an example of information registered in a dictionary.

FIG. 9 is a diagram illustrating an example of a display mode of an image and additional information.

FIG. 10 is a flowchart illustrating an example of a flow of a process of creating a dictionary.

FIG. 11 is a flowchart illustrating an example of a process performed by the information generation device.

FIG. 12 is a block diagram illustrating an example of functions of the information generation device including an accepting unit.

FIG. 13A is a diagram illustrating an example of edition of a dictionary.

FIG. 13B is a diagram illustrating an example of edition of a dictionary.

FIG. 14 is a diagram illustrating an example of a ladder program.

FIG. 15 is a diagram illustrating an example of information registered in a dictionary.

### DETAILED DESCRIPTION OF EMBODIMENTS OF THE INVENTION

An information generation device according to an embodiment of the present disclosure will be described below with reference to the drawings. Note that not all combinations of features described in the following embodiments are necessarily required to solve the problem. Further, more detailed description than is needed may be omitted. Further, the following description of the embodiment and the drawings are provided for those skilled in the art to fully understand the present disclosure and are not intended to limit the scope of the claims.

The information generation device is implemented on a control device that controls an industrial machine, for example. The information generation device may be implemented on a server, a personal computer (PC), or a mobile tablet device connected to the control device via a wired connection or a wireless connection.

The industrial machine includes a machine tool, an injection molding machine, a wire electric discharge machine, and an industrial robot. The machine tool is, for example, a lathe, a machining center, a drilling center, and a combined machine. The control device is, for example, a numerical control device that controls an industrial machine. The following description will be provided for an embodiment in which the information generation device is implemented on a control device that controls a machine tool.

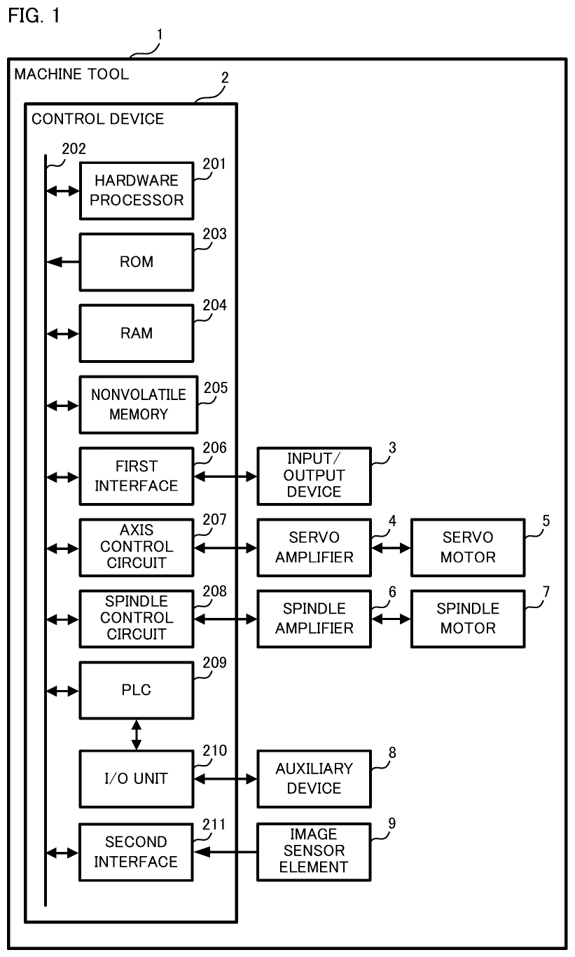

FIG. 1 is a block diagram illustrating an example of a hardware configuration of a machine tool including a control device.

A machine tool 1 includes a control device 2, an input/output device 3, a servo amplifier 4, a servo motor 5, a spindle amplifier 6, a spindle motor 7, an auxiliary device 8, and an image sensor element 9.

The control device 2 is a device that controls the entire machine tool 1. The control device 2 includes a hardware processor 201, a bus 202, a read only memory (ROM) 203, a random access memory (RAM) 204, and a nonvolatile memory 205.

The hardware processor 201 is a processor that controls the entire control device 2 in accordance with a system program. The hardware processor 201 reads the system program stored in the ROM 203 via the bus 202 and performs various processes based on the system program. The hardware processor 201 controls the servo motor 5 and the spindle motor 7 based on a machining program. The hardware processor 201 is, for example, a central processing unit (CPU) or an electronic circuit.

For example, the hardware processor 201 analyzes a machining program and outputs control instructions to the servo motor 5 and the spindle motor 7 in each control cycle.

The bus 202 is a communication path connecting respective hardware components within the control device 2 to each other. These hardware components within the control device 2 transfer data via the bus 202.

The ROM 203 is a storage device that stores the system program for controlling the entire control device 2 or the like. The ROM 203 may store an information generating program. The information generating program is a program to be executed in the information generation device. The ROM 203 is a computer-readable storage medium.

The RAM 204 is a storage device that temporarily stores various data. The RAM 204 functions as a work area where the hardware processor 201 processes various data.

The nonvolatile memory 205 is a storage device that holds data even in a state where the machine tool 1 is powered off and no power is supplied to the control device 2. The nonvolatile memory 205 stores a machining program and various parameters, for example. The nonvolatile memory 205 is a computer-readable storage medium. The nonvolatile memory 205 is formed of a memory backed up by a battery or a solid state drive (SSD), for example.

The control device 2 further includes a first interface 206, an axis control circuit 207, a spindle control circuit 208, a programmable logic controller (PLC) 209, an I/O unit 210, and a second interface 211.

The first interface 206 connects the bus 202 and the input/output device 3 to each other. The first interface 206 transmits various data processed by the hardware processor 201 to the input/output device 3, for example.

The input/output device 3 is a device that receives various data via the first interface 206 and displays the various data. Further, the input/output device 3 accepts input of various data and transmits the various data to the hardware processor 201, for example, via the first interface 206.

The input/output device 3 is a touch panel, for example. When the input/output device 3 is a touch panel, the input/output device 3 is a capacitive touch panel, for example. Note that the touch panel may be other types of touch panels without being limited to the capacitive type. The input/output device 3 is installed to an operation panel (not illustrated) in which the control device 2 is stored.

The axis control circuit 207 is a circuit that controls the servo motor 5. In response to receiving a control instruction from the hardware processor 201, the axis control circuit 207 outputs an instruction for driving the servo motor 5 to the servo amplifier 4. For example, the axis control circuit 207 transmits a torque command for controlling the torque of the servo motor 5 to the servo amplifier 4.

In response to receiving an instruction from the axis control circuit 207, the servo amplifier 4 supplies current to the servo motor 5.

The servo motor 5 is driven in response to being supplied with current from the servo amplifier 4. The servo motor 5 is connected to a ball screw that drives a tool rest, for example. In response to the servo motor 5 being driven, the structure of the machine tool 1 such as a tool rest moves in each control axis direction. The servo motor 5 has a built-in encoder (not illustrated) that detects the position of the control axis and the feed rate. Position feedback information and rate feedback information indicating the position of the control axis and the feed rate of the control axis, respectively, which are detected by the encoder, are fed back to the axis control circuit 207. Accordingly, the axis control circuit 207 performs feedback control of the control axis.

The spindle control circuit 208 is a circuit for controlling the spindle motor 7. In response to receiving a control instruction from the hardware processor 201, the spindle control circuit 208 transmits an instruction for driving the spindle motor 7 to the spindle amplifier 6. For example, the spindle control circuit 208 transmits a spindle rate command for controlling a rotational rate of the spindle motor 7 to the spindle amplifier 6.

In response to receiving an instruction from the spindle control circuit 208, the spindle amplifier 6 supplies current to the spindle motor 7.

The spindle motor 7 is driven in response to being supplied with current from the spindle amplifier 6. The spindle motor 7 is connected to the spindle and rotates the spindle.

The PLC 209 is a device that executes a ladder program to control the auxiliary device 8. The PLC 209 transmits an instruction to the auxiliary device 8 via the I/O unit 210.

The I/O unit 210 is an interface connecting the PLC 209 and the auxiliary device 8 to each other. The I/O unit 210 transmits an instruction received from the PLC 209 to the auxiliary device 8.

The auxiliary device 8 is a device installed to the machine tool 1 and configured to perform an auxiliary operation in the machine tool 1. The auxiliary device 8 operates based on an instruction received from the I/O unit 210. The auxiliary device 8 may be a device installed in the periphery of the machine tool 1. The auxiliary device 8 is, for example, a tool exchanger, a cutting liquid injector, or an open/closure door drive device.

The second interface 211 connects the bus 202 and the image sensor element 9 to each other. The second interface 211 transmits image data taken by the image sensor element 9 to the hardware processor 201.

The image sensor element 9 is a component that converts light emitted from an object and input through a lens into digital image data and outputs the digital image data. The image sensor element 9 is also referred to as an image sensor. For example, the image sensor element 9 is mounted on a camera.

Next, functions of an information generation device 20 will be described.

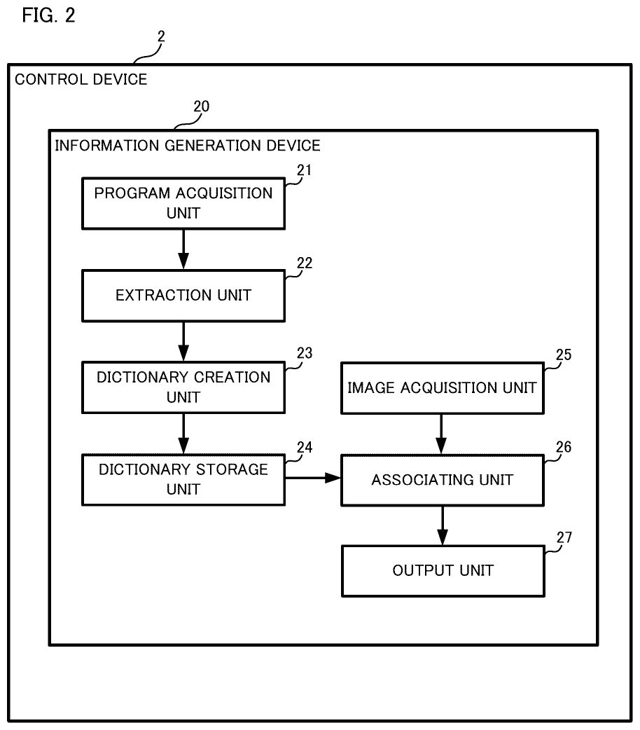

FIG. 2 is a block diagram illustrating an example of the functions of the information generation device 20 implemented on the control device 2. The information generation device 20 includes a program acquisition unit 21, an extraction unit 22, a dictionary creation unit 23, a dictionary storage unit 24, an image acquisition unit 25, an associating unit 26, and an output unit 27.

The program acquisition unit 21, the extraction unit 22, the dictionary creation unit 23, the image acquisition unit 25, the associating unit 26, and the output unit 27 are implemented when the hardware processor 201 performs computation processing by using a system program and an information generating program stored in the ROM 203 and various data stored in the nonvolatile memory 205, for example. The dictionary storage unit 24 is implemented with various data being stored in the RAM 204 or the nonvolatile memory 205.

The program acquisition unit 21 acquires a program to be executed in the control device 2 that controls the machine tool 1. The program acquisition unit 21 acquires a program from the nonvolatile memory 205 of the control device 2, for example. The program includes a machining program, a sequence program, a system program, and an embedded program.

The machining program refers to a program for operating each axis of the machine tool 1 to machine a workpiece.

The sequence program refers to a program for causing the PLC 209 to operate in accordance with sequence control. The sequence control refers to control to sequentially proceed with control in accordance with predetermined order or logic. The sequence program includes a ladder program and a function block.

The system program refers to a program for causing Operating System (OS) of the control device 2 to operate. Further, the system program is a program implemented on the control device 2 by the vender of the control device 2.

The embedded program refers to a program for assisting the system program. Further, the embedded program is a program for the user including the operator of the control device 2 to customize the system program.

The extraction unit 22 extracts an element forming the program and additional information added to the element from a program acquired by the program acquisition unit 21. The element forming a program represents various codes and symbols included in the program. The additional information added to an element is a comment formed of a character string. The additional information may be a figure. The additional information is information for describing an element. The additional information may be a symbol name for identifying an element.

When the program is a machining program, the element forming the program includes G code, M code, F code, and S code. Further, the element forming a program may include a macro variable.

When the program is a sequence program, the element forming the program includes a character symbol. The character symbol includes an address indicating a location where a device is present.

When the program is a system program, the element forming the program represents various codes included in the system program. The various codes are codes described in various programming languages.

When the program is an embedded program, the element forming the program corresponds to various codes included in the embedded program. The various codes are codes described in various programming languages.

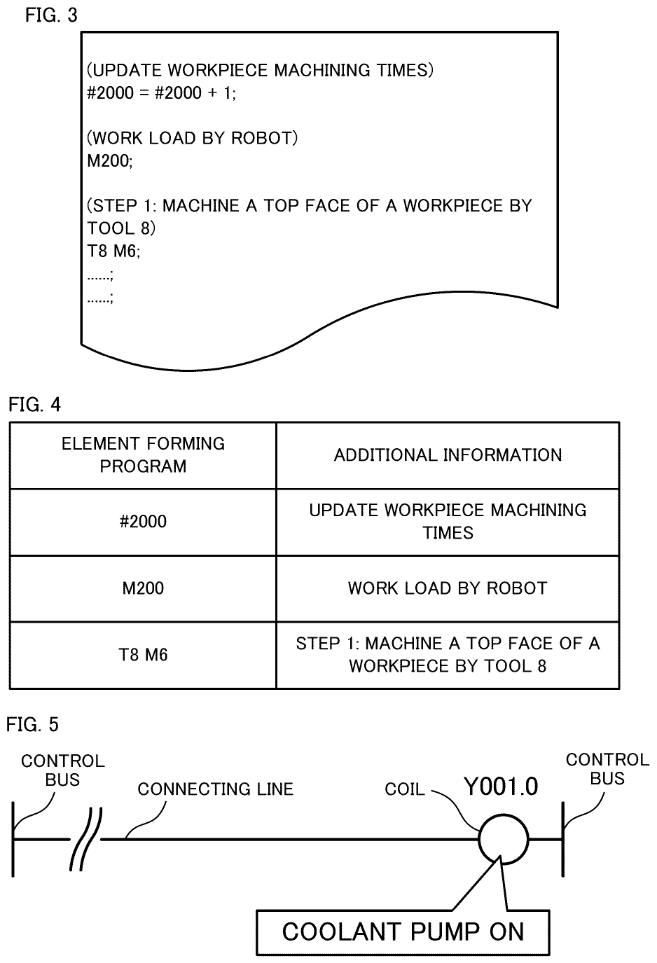

FIG. 3 is a diagram illustrating an example of the machining program. The character string interposed between parentheses is additional information. The text “UPDATE WORKPIECE MACHINING TIMES” is additional information describing that the instruction described on the next line is an instruction to update the number of times of machining on a workpiece.

The character string starting from “#” denoted on the line following “(UPDATE WORKPIECE MACHINING TIMES)”, that is, “#2000” is a macro variable. As described in the additional information, the text “#2000=#2000+1;” is an instruction to update the number of machining times on a workpiece. That is, the value of the macro variable “#2000” is added by 1 every time machining on a workpiece starts or ends.

The text “WORK LOAD BY ROBOT” is additional information describing that the instruction described on the next line is an instruction to cause a robot to transport a workpiece. As described in the additional information, the text “M200;” is an instruction to cause a robot to transport a workpiece.

The text “STEP 1: MACHINE A TOP FACE OF A WORKPIECE BY TOOL 8” is additional information describing that an instruction described on the next and subsequent lines is an instruction to machine the top face of a workpiece by using a tool whose tool number is 8. The text “T8 M6;” is an instruction to exchange the tool with a tool whose tool number is 8.

For example, the extraction unit 22 extracts the macro variable “#2000” which is an element forming the program, and the additional information “UPDATE WORKPIECE MACHINING TIMES” as one set. Further, the extraction unit 22 extracts the element “M200;” forming the program and the additional information “WORK LOAD BY ROBOT” as one set. Further, the extraction unit 22 extracts the element “T8 M6;” forming the program and the additional information “STEP 1: MACHINE WORKPIECE TOP FACE BY TOOL 8” as one set.

For example, the extraction unit 22 extracts a character string interposed between parentheses and a macro variable or an instruction described on the line following this character string, respectively, as additional information and an element forming a program.

The dictionary creation unit 23 creates a dictionary in which an element forming a program and additional information extracted by the extraction unit 22 are associated with each other. Associating is to register an element forming a program and additional information in association with each other. The dictionary can also be said as a table in which an element forming a program and additional information are associated with each other.

FIG. 4 is a diagram illustrating an example of information registered in a dictionary. In the dictionary, the elements “#2000”, “M200”, and “T8 M6” that form a program extracted by the extraction unit 22 are associated with the additional information “UPDATE WORKPIECE MACHINING TIMES”, “WORK LOAD BY ROBOT”, and “STEP 1: MACHINE A TOP FACE OF A WORKPIECE BY TOOL 8”, respectively.

FIG. 5 is a diagram illustrating an example of a ladder program. The line extending in the left-right direction is a connecting line. The lines extending vertically on both sides of the connecting line are control buses. The circular graphic symbol depicted on the connecting line represents a coil. The text “Y001.0” depicted in the area above the coil is a character string representing an address. The character string described in the balloon in contact with the graphic symbol is additional information.

The extraction unit 22 extracts the character string “COOLANT PUMP ON” described in the balloon and the address “Y001.0” described adjacently to the graphic symbol of the coil, respectively, as additional information and an element forming a program.

The dictionary creation unit 23 creates a dictionary in which an element forming a program and additional information extracted by the extraction unit 22 are associated with each other. Note that, when an address is extracted from a ladder program by the extraction unit 22, the dictionary creation unit 23 may append a character string of “=1” after the character string indicating the address to create the dictionary. In such a case, the dictionary associates the element forming a program and the control state thereof with the additional information.

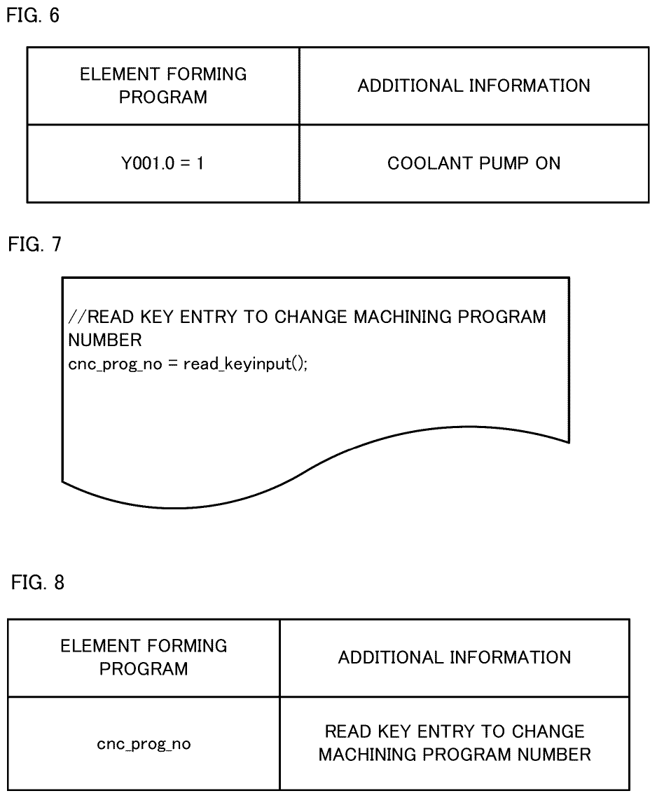

FIG. 6 is a diagram illustrating an example of information registered in a dictionary. In the dictionary, the element that forms a program and a control state extracted by the extraction unit 22 are associated with the additional information. Specifically, “Y001.0=1” and “COOLANT PUMP ON” are associated with each other. That is, the additional information registered in the dictionary illustrated in FIG. 6 describes that, when the state of “Y001.0” is “1”, a coolant pump is turned on.

FIG. 7 is a diagram illustrating an example of an embedded program. The character string “READ KEY ENTRY TO CHANGE MACHINING PROGRAM NUMBER” after “//” is additional information. The instruction “cnc_prog_no=read_keyinput( );” described on the line following the additional information is an instruction to read key entry to change the machining program number, as described in the additional information.

The extraction unit 22 extracts the character string described after “//” and the shared variable “cnc_prog_no” described on the line following the above character string, respectively, as additional information and an element forming a program. Note that a shared variable means a memory area accessible from both the system program and the embedded program, for example.

The dictionary creation unit 23 creates a dictionary in which an element forming a program and additional information extracted by the extraction unit 22 are associated with each other.

FIG. 8 is a diagram illustrating an example of information registered in a dictionary. In the dictionary, the element “cnc_prog_no” that forms a program extracted by the extraction unit 22 are associated with the additional information “READ KEY ENTRY TO CHANGE MACHINING PROGRAM NUMBER”.

The dictionary storage unit 24 stores a dictionary created by the dictionary creation unit 23. The dictionary storage unit 24 may store a dictionary accepted from outside of the information generation device 20 in addition to the dictionary created by the dictionary creation unit 23.

The image acquisition unit 25 acquires an image indicating the state of the machine tool 1. For example, the image indicating the state of the machine tool 1 is an image acquired from a camera that takes the external appearance of the machine tool 1. The image includes at least any one of a static image and a moving image. For example, the image acquisition unit 25 acquires image data from a camera that takes machining region of a workpiece. The image acquisition unit 25 sequentially acquires images taken at a predetermined frame rate from the camera.

The image indicating the state of the machine tool 1 may be an image displayed on a display screen of the input/output device 3. That is, the image acquired by the image acquisition unit 25 may be a capture image in which an image displayed on the display screen of the input/output device 3 is captured. The image acquisition unit 25 acquires an image displayed on the input/output device 3 from a capture device (not illustrated). For example, the image acquisition unit 25 starts acquisition of an image displayed on the display screen of the input/output device 3 in response to start of execution of a machining program in the machine tool 1.

The associating unit 26 associates an image acquired by the image acquisition unit 25 with additional information associated with the element forming the program in a dictionary when the control state related to an element forming a program is changed in the control device 2. The control state related to an element forming a program includes at least any one of the state of a signal, the state of a macro variable, and the state of a shared variable. That is, a change in the control state includes changes in the value of a signal, a change in the value of a macro variable, and a change in the value of a shared variable.

When the control device 2 executes the machining program illustrated in FIG. 3, the control state changes when the value of the macro variable “#2000” changes. Further, the control state changes when a signal for performing transportation of a workpiece based on the instruction “M200;” changes. Further, the control state changes when a signal for performing tool exchange based on the instruction “T8 M6;” changes.

The image acquired by the image acquisition unit 25 at a change of the control state related to an element forming a program corresponds to one frame acquired by the image acquisition unit 25 at the same timing as the timing of the change of the control state related to the element forming the program. Herein, “the same” does not necessarily require to be the same in a strict sense and may be differ within a range from several milliseconds to several seconds.

The associating unit 26 associates an image acquired at a timing of a change of the value of the macro variable “#2000” with the additional information “UPDATE WORKPIECE MACHINING TIMES” associated with the element “#2000” in the dictionary illustrated in FIG. 4.

The associating unit 26 associates an image acquired at a timing of a change of a predetermined signal related to transportation of a workpiece performed by a robot based on the instruction “M200;” with the additional information “WORK LOAD BY ROBOT” associated with the element “M200;” in the dictionary illustrated in FIG. 4.

The associating unit 26 associates an image acquired at a timing of a change of a predetermined signal related to tool exchange based on the instruction “T8 M6;” with the additional information “STEP 1: MACHINE A TOP FACE OF A WORKPIECE BY TOOL 8” associated with the element “T8 M6;” in the dictionary illustrated in FIG. 4.

When the control device 2 executes the ladder program illustrated in FIG. 5, the control state changes when the value of the signal for the address “Y001.0” changes from 0 to 1.

The associating unit 26 associates an image acquired at the timing of the change from 0 to 1 of the value of the signal for the address “Y001.0” with the additional information “COOLANT PUMP ON” associated with the element “Y001.0” in the dictionary illustrated in FIG. 6.

When the control device 2 executes the embedded program illustrated in FIG. 7, the control state changes when the shared variable expressed by “cnc_prog_no” is changed to the number provided by key entry.

The associating unit 26 associates an image acquired at the timing of the change of the program number expressed by “cnc_prog_no” to the number provided by key entry with the additional information “READ KEY ENTRY TO CHANGE MACHINING PROGRAM NUMBER” associated with the element “cnc_prog_no” in the dictionary illustrated in FIG. 8.

The state of the signal includes the state of a signal based on a machining program instruction and the state of a signal based on a sequence program instruction. The signal based on a machining program instruction changes as the instruction designated by the machining program is executed. The instruction designated by the machining program is a tool exchange instruction “M6”, for example. A signal based on a sequence program instruction changes as the sequence program is executed. The signal changed as the sequence program is executed is a specific function in-progress signal, for example.

The output unit 27 outputs an image acquired by the image acquisition unit 25. Further, the output unit 27 outputs additional information associated with an image by the associating unit 26. For example, the output unit 27 outputs the image and the additional information to the input/output device 3.

The output unit 27 may output additional information so that the additional information is displayed superimposed on an image associated with the additional information by the associating unit 26 and an image corresponding to a predetermined number of frames acquired following the former image. Accordingly, the additional information is displayed on the display screen of the input/output device 3 during a predetermined period, superimposed on an image acquired by the image acquisition unit 25.

In response to accepting an image and additional information associated with each other by the associating unit 26, the input/output device 3 displays the image and the additional information on the display screen.

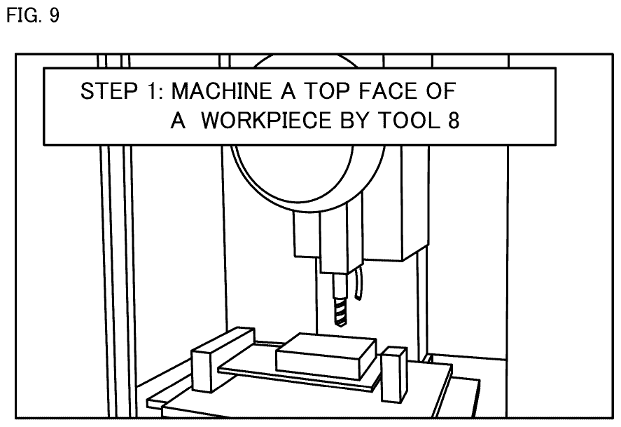

FIG. 9 is a diagram illustrating an example of a display screen of the input/output device 3. The additional information “STEP 1: MACHINE ATOP FACE OF A WORKPIECE BY TOOL 8” is displayed on the display screen superimposed on an image acquired by the image acquisition unit 25. Note that the additional information may be displayed adjacent to the image acquired by the image acquisition unit 25.

Next, the process performed in the information generation device 20 will be described. First, a flow of the process of generating a dictionary performed by the information generation device 20 will be described.

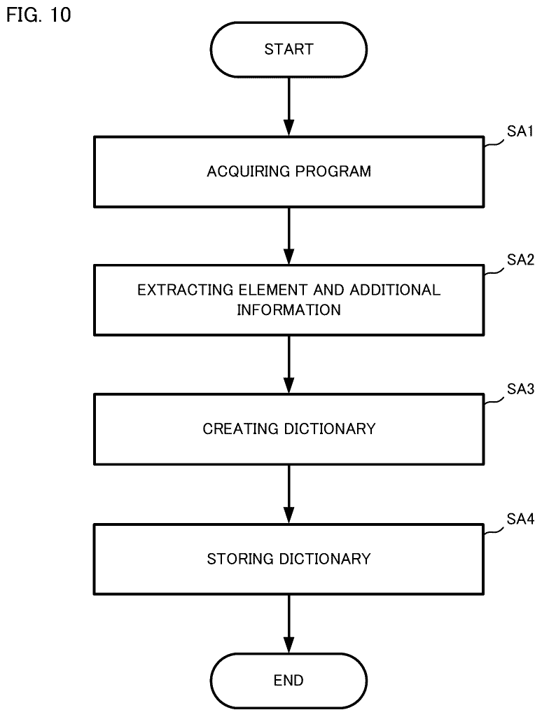

FIG. 10 is a flowchart illustrating an example of a flow of the process of creating a dictionary performed by the information generation device 20. First, the program acquisition unit 21 acquires a program executed in the control device 2 that controls the machine tool 1 (step SA1).

Next, the extraction unit 22 extracts an element forming the program and additional information added to the element forming the program from the program acquired by the program acquisition unit 21 (step SA2).

Next, the dictionary creation unit 23 creates a dictionary in which the element forming the program and the additional information extracted by the extraction unit 22 are associated with each other (step SA3).

Next, the dictionary storage unit 24 stores the dictionary created by the dictionary creation unit 23 (step SA4) and ends the process. With the above process being performed, the dictionary is created in the information generation device 20.

Next, the process performed in the information generation device 20 during operation of the machine tool 1 will be described.

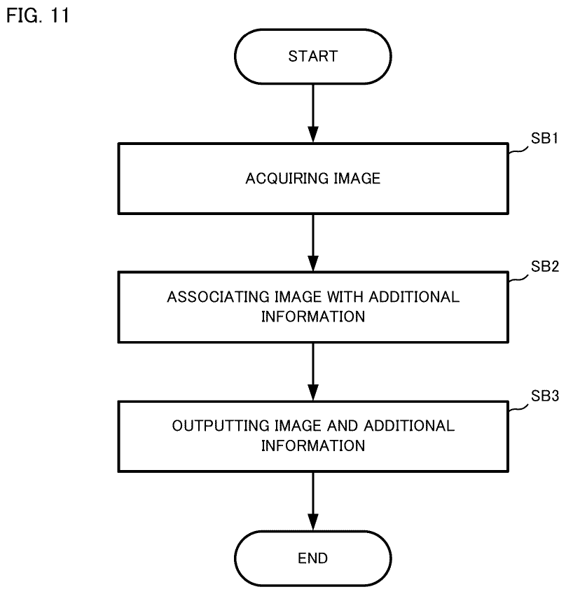

FIG. 11 is a diagram illustrating an example of the process performed in the information generation device 20 during operation of the machine tool 1. Once execution of a machining program is started in the machine tool 1, the image acquisition unit 25 starts acquisition of an image of the machine tool 1 (step SB1).

Next, the associating unit 26 associates the image acquired by the image acquisition unit 25 when the control state related to the element changes in the control device 2 with the additional information associated with the element in the dictionary (step SB2).

Next, the output unit 27 outputs the image and the additional information associated with each other by the associating unit 26 (step SB3). When the operation of the machine tool 1 ends, the information generation device 20 ends this process.

As described above, the information generation device 20 includes the program acquisition unit 21 that acquires a program executed in the control device 2 configured to control an industrial machine, the extraction unit 22 that extracts an element forming the program and additional information added to the element from the program acquired by the program acquisition unit 21, and the dictionary creation unit 23 that creates a dictionary in which the element and the additional information extracted by the extraction unit 22 are associated with each other.

Therefore, the information generation device 20 can automatically create a dictionary in which an element forming a program and additional information are associated with each other. Thus, the operator does not need to create and store a dictionary in a storage unit in advance. As a result, the workload on the operation made by the operator can be reduced.

Further, the information generation device 20 further includes the image acquisition unit 25 that acquires an image of the industrial machine taken by the image sensor element 9, the associating unit 26 that associates the image acquired by the image acquisition unit 25 when the control state related to the element changes in the control device 2 with additional information associated with the element in the dictionary, and the output unit 27 that outputs the image and the additional information associated with the associating unit 26. Therefore, the information generation device 20 enables the operator to easily understand the control state of the control device 2.

Further, the control state includes at least any one of the state of the signal, the state of the macro variable, and the state of the shared variable. Therefore, the information generation device 20 can display additional information together with an image in association with various changes in the control state in the control device 2.

Further, the program includes at least any one of a machining program, a sequence program, a system program, and an embedded program. Therefore, the information generation device 20 can display additional information together with an image in association with a change in the control state when various programs are executed.

Further, the additional information includes at least any one of a comment and a symbol name. Therefore, the information generation device 20 enables the operator to easily, visually understand the control state of the control device 2.

The information generation device 20 in the embodiment described above may further include an accepting unit that accepts edition information used for editing additional information associated with an element forming a program in a dictionary.

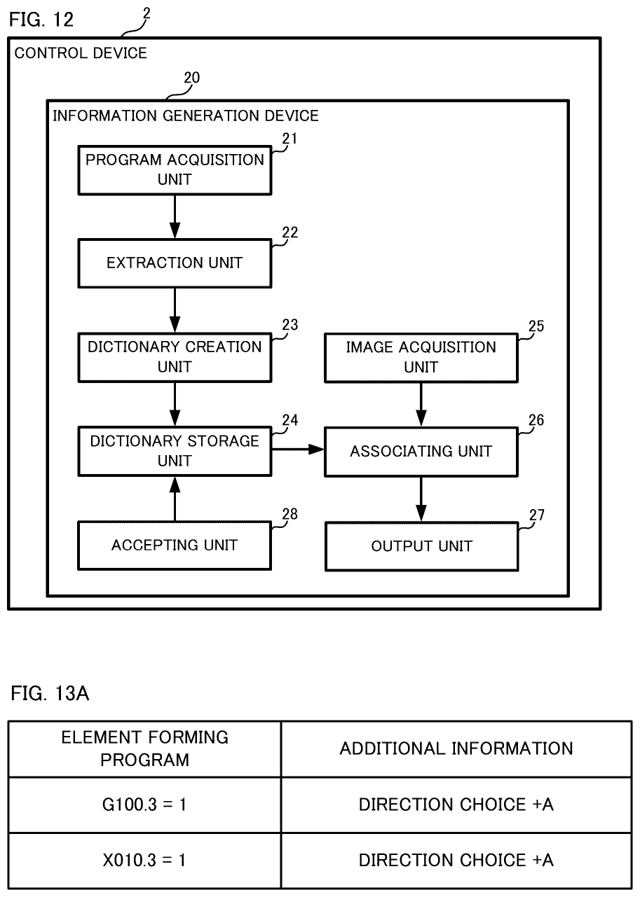

FIG. 12 is a block diagram illustrating an example of functions of the information generation device 20 including the accepting unit. An accepting unit 28 accepts an edition information used for editing additional information from a touch panel of the input/output device 3, for example.

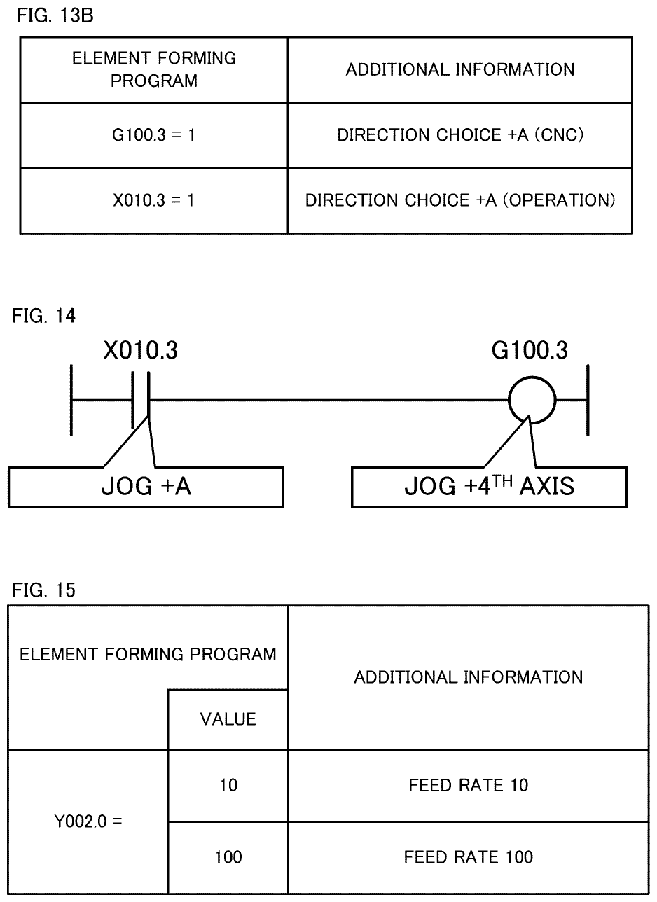

FIG. 13A and FIG. 13B are diagrams illustrating edition of dictionaries. In the dictionary illustrated in FIG. 13A, additional information “DIRECTION CHOICE +A” is associated with an element “G100.3=1” forming a program. Further, in the dictionary, the additional information “DIRECTION CHOICE +A” is stored in association with an element “X010.3=1” forming a program. In such a case, when the value of the signal for the address “G100.3” changes from 0 to 1, the additional information “DIRECTION CHOICE +A” is output. Similarly, also when the value of the signal for the address “X010.3” changes from 0 to 1, the additional information “DIRECTION CHOICE +A” is output. Thus, only by viewing the displayed additional information, the operator may be unable to determine whether the value of the signal for the address “X010.3” has changed or the value of the signal for the address “G100.3” has changed. In such a case, the operator may input edition information to the accepting unit 28 via the input/output device 3, for example.

FIG. 13B illustrates an example of the dictionary after edition. A character string “(CNC)” has been added to the additional information “DIRECTION CHOICE +A” associated with the element “G100.3=1”. In such a case, the accepting unit 28 accepts edition information used for changing “DIRECTION CHOICE +A” to “DIRECTION CHOICE +A (CNC)”. Further, a character string “(OPERATION)” has been added to the additional information “DIRECTION CHOICE +A” associated with the element “X010.3=1”. In such a case, the accepting unit 28 accepts edition information used for changing “DIRECTION CHOICE +A” to “DIRECTION CHOICE +A (OPERATION)”. This enables the operator to easily understand whether the value of the signal for the address “G100.3” has been changed in accordance with processing of a computerized numerical control (CNC) device or the value of the signal for the address “X010.3” has been changed based on its operation.

The accepting unit 28 may accept deletion information used for deleting information registered in a dictionary. In such a case, the accepting unit 28 accepts the deletion information used for deleting additional information from the touch panel of the input/output device 3. By deleting some information registered in the dictionary, it is possible to prevent pieces of similar additional information from being displayed on the display screen at the same time.

FIG. 14 is a diagram illustrating an example of a ladder program. In the ladder program illustrated in FIG. 14, a contact point indicated by the address “X010.3” to which the additional information “JOG +A” is added and a coil indicated by the address “G100.3” to which the additional information “JOG +4^{TH} AXIS” is added are arranged on a single connecting line. In this ladder program, the value of the signal for the address “X010.3” and the value of the signal for the address “G100.3” change at the same timing. Therefore, when both of the set of “X010.3” and “JOG +A” and the set of “G100.3” and “JOG +4^{TH} AXIS” are registered in the dictionary, these pieces of additional information similar to each other may be displayed on the display screen at the same time.

Therefore, the accepting unit 28 accepts deletion information used for deleting any one of the sets registered in the dictionary, and it is thus possible to prevent “JOG +A” and “JOG +4^{TH} AXIS” from being displayed on the display screen at the same time.

In the embodiment described above, the dictionary creation unit 23 associates a single piece of additional information with a single element to create a dictionary. However, the dictionary creation unit 23 may associate multiple pieces of additional information with a single element to create a dictionary. Further, when multiple pieces of additional information are associated with a single element in a dictionary, the accepting unit 28 may accept selection information for selecting any of the multiple pieces of additional information registered in the dictionary. In such a case, the accepting unit 28 accepts selection information used for selecting additional information from the touch panel of the input/output device 3.

For example, when the additional information “COOLANT PUMP ON” is associated with the address “Y001.0” written in Japanese and English, respectively, the accepting unit 28 may accept additional information used for selecting additional information written in any one of these languages.

Further, when the control state related to an element forming a program changes between at least a first state and a second state, the dictionary creation unit 23 may create a dictionary in which a single element is associated with two types of additional information, namely, additional information indicating the first state and additional information indicating the second state.

FIG. 15 is a diagram illustrating an example of a dictionary in which two types of additional information are associated with a single element. For example, in a ladder program, the signal for the address “Y002.0” changes between “10” and “100”, and additional information “FEED RATE” is added to the address “Y002.0”. The dictionary creation unit 23 associates the additional information “FEED RATE” with values that may be taken by “Y002.0”, respectively. Furthermore, when it is predefined in a predetermined storage area that the signal for the address “Y002.0” changes between “10” and “100”, the dictionary creation unit 23 appends the values that may be taken by the address “Y002.0” after the additional information “FEED RATE”. Accordingly, it is possible to display the additional information “FEED RATE 10” and “FEED RATE 100” in association with the plurality of values “10” and “100”, respectively, which may be taken by a single element.

The present disclosure is not limited to the embodiment described above and can be changed as appropriate within the scope not departing from the spirit. In the present disclosure, modification of any component of the embodiment or omission of any component of the embodiment is possible.

### LIST OF REFERENCE SYMBOLS

1 machine tool
2 control device
20 information generation device
21 program acquisition unit
22 extraction unit
23 dictionary creation unit
24 dictionary storage unit
25 image acquisition unit
26 associating unit
27 output unit
28 accepting unit
201 hardware processor
202 bus
203 ROM
204 RAM
205 nonvolatile memory
206 first interface
207 axis control circuit
208 spindle control circuit
209 PLC
210 I/O unit
211 second interface
3 input/output device
4 servo amplifier
5 servo motor
6 spindle amplifier
7 spindle motor
8 auxiliary device
9 image sensor element

1. An information generation device comprising:
a program acquisition unit that acquires a program executed in a control device configured to control an industrial machine;
an extraction unit that extracts an element forming the program and additional information added to the element from the program acquired by the program acquisition unit; and
a dictionary creation unit that creates a dictionary in which the element and the additional information extracted by the extraction unit are associated with each other.

2. The information generation device according to claim 1 further comprising:
an image acquisition unit that acquires an image indicating a state of the industrial machine;
an associating unit that associates the image acquired by the image acquisition unit when a control state related to the element changes in the control device with the additional information associated with the element in the dictionary; and
an output unit that outputs the image and the additional information associated with each other by the associating unit.

3. The information generation device according to claim 2, wherein the control state related to the element changes between at least a first state and a second state, and the dictionary creation unit creates the dictionary in which the element is associated with the additional information indicating the first state and the additional information indicating the second state.

4. The information generation device according to claim 2, wherein the control state includes at least any one of a state of a signal, a state of a macro variable, and a state of a shared variable.

5. The information generation device according to claim 3, wherein the control state includes at least any one of a state of a signal, a state of a macro variable, and a state of a shared variable.

6. The information generation device according to claim 1, wherein the program includes at least any one of a machining program, a sequence program, a system program, and an embedded program.

7. The information generation device according to claim 1, wherein the additional information includes at least any one of a comment and a symbol name.

8. The information generation device according to claim 1, further comprising an accepting unit that accepts edition information used for editing the additional information associated with the element in the dictionary.

9. A computer-readable storage medium storing an instruction that causes a computer to perform:
acquiring a program executed in a control device configured to control an industrial machine;
extracting an element forming the program and additional information added to the element from the acquired program; and
creating a dictionary in which the extracted element and the extracted additional information are associated with each other.
